(19) United States
(12) Patent Application Publication
(10) Pub. No.: US 2007/0211727 A1
(43) Pub. Date: Sep. 13, 2007

(54) System and method for scheduling delivery of traffic in a wireless network

(76) Inventors: Aseem Sethi, Bangalore (IN); Naresh Sunkara, Bangalore (IN); Amit Phadnis, Bangalore (IN)

Correspondence Address: FAY KAPLUN & MARCIN, LLP, 15O BROADWAY, SUITE 702, NEW YORK, NY, 10038, US

(21) Appl. No.: 11/370,110

(22) Filed: Mar. 7, 2006

(51) Int. Cl. H04L 12/56

(52) U.S. Cl. 370/395.4

(57) ABSTRACT

Described is a system and method for scheduling delivery of traffic in a wireless network. The method comprises receiving packets addressed to a plurality of wireless computing units. A classification of each packet is determined. A transmission schedule is generated for the corresponding packet as a function of at least one of the classification and a priority request from at least one of the plurality of units. An indication message is generated as a function of the transmission schedule. A signal including the indication message is wirelessly transmitted.

### BACKGROUND INFORMATION

In a conventional wireless network, an access point (“AP”) transmits a beacon at a regular interval to synchronize devices on the network. The beacon includes a traffic indication map (“TIM”) which is a bitmap indicating one or more wireless computing units (e.g., mobile units (“MU”)) that have data traffic buffered at the AP. When the MU is in a power-save mode and the TIM indicates that there is traffic for the MU, the MU switches to a wake mode and polls the AP to receive the traffic. However, each MU that was identified in the TIM switches to the wake mode at substantially the same time and immediately begins contending for access to a radio frequency (“RF”) channel. These MUs also contend with other MUs that are waiting to transmit data to the AP. Thus, the MUs that are switching to the wake mode only to receive the traffic from the AP are consuming a significant amount of power (e.g., battery) in attempting to download the traffic from the AP. Contention for the RF channel by all of the MUs indicated in the TIM at substantially the same time may also negatively impact throughput of the network.

### SUMMARY OF THE INVENTION

The present invention relates to a system and method for scheduling delivery of traffic in a wireless network. The method comprises receiving packets addressed to a plurality of wireless computing units. A classification of each packet is determined. A transmission schedule is generated for the corresponding packet as a function of at least one of the classification and a priority request from at least one of the plurality of units. An indication message is generated as a function of the transmission schedule. A signal including the indication message is wirelessly transmitted.

### BRIEF DESCRIPTION OF THE DRAWINGS

FIG. 1 is an exemplary embodiment of a system according to the present invention; and

FIG. 2 is an exemplary embodiment of a method according to the present invention.

### DETAILED DESCRIPTION

The present invention may be further understood with reference to the following description and the appended drawings, wherein like elements are provided with the same reference numerals. The present invention provides a system and a method for scheduling delivery of traffic in a wireless environment. Although the present invention will be described with respect to a wireless local area network (“WLAN”), those of skill in the art will understand that the present invention may be implemented in any wired and/or wireless communications network.

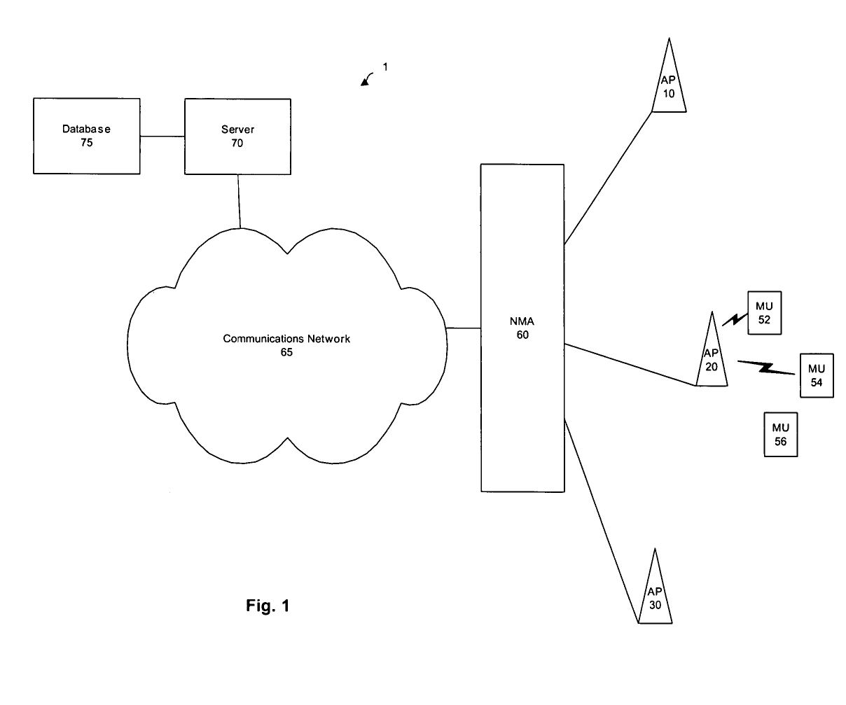

FIG. 1 shows an exemplary embodiment of a system 1 according to the present invention. The system 1 may include a network management arrangement (“NMA”) 60 coupled to a communications network 65 (e.g., wired/wireless local/wide area network, the Internet, etc.). The NMA 60 may include one or more network computing devices (e.g., a router, a switch, etc.) for sending and receiving a data request over the network 65. The NMA 60 may be further coupled to a server 70 and/or a database 75 via the network 65.

One or more access points (“APs”) 10, 20, 30 are coupled to the NMA 60 and provide a wireless connection for one or more mobile units (“MUs”) 52, 54, 56 to the network 65. Those skilled in the art will understand that the system 1 may include any number of the APs and the MUs. Each MU may be any mobile computing unit, such as, for example, an image or laser-based scanner, a radio frequency identification (“RFID”) reader or tag, a cell phone, a laptop, a network interface card, a handheld computer and a PDA, or any combination thereof.

Each MU may utilize a dedicated power source, such as, for example, a rechargeable battery. To prolong a life of the battery, the MU may utilize a first mode (e.g., a power-save mode) for which the MU does not transmit any wireless signals, but may listen to signals within its RF range. For example, the MU may hear beacons transmitted by one or more of the APs 10-30. In a second mode (e.g., a wake mode), the MU may be capable of conducting wireless communications (e.g., transmitting packets).

When an AP receives traffic from the network 65 for an MU, the AP may transmit the traffic to the MU if it is in the wake mode. However, when the MU is in the power-save mode, the AP buffers the traffic and sets a bit in a traffic indication message (“TIM”) included in the beacon. The TIM includes data indicating that the AP is buffering traffic for one or more MUs and that those MUs should switch to the wake mode to download the traffic. Those of skill in the art will understand that the traffic may include any number and type of packet (e.g., data, voice, video, etc.).

According to the present invention, the AP (e.g., AP 20) may utilize a scheduling algorithm when downloading traffic to the MUs associated therewith (e.g., MUs 52-56). The scheduling algorithm may utilize input data (e.g., a type of data being transmitted, a priority request by an MU, etc.) to generate output data (e.g., a transmission schedule for delivering the traffic to the MUs). In an exemplary embodiment, the AP implements the transmission schedule by delaying the indication in TIM of buffered data for particular MUs. Thus, higher priority data (e.g., voice, emergency, etc.) may be downloaded faster, because the recipient MUs may have to contend with less MUs than in conventional systems.

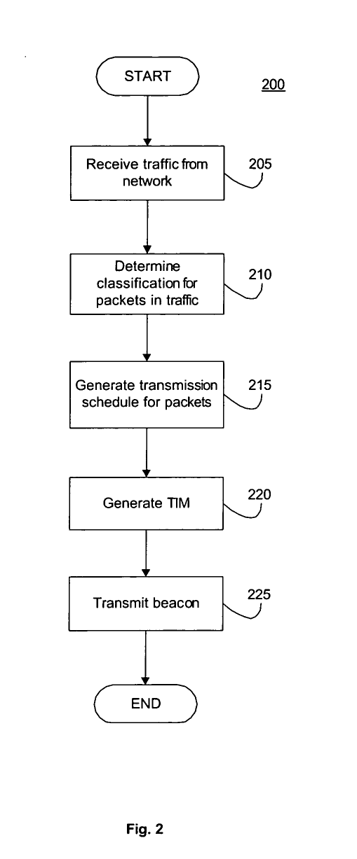

FIG. 2 shows an exemplary embodiment of a method 200 for scheduling delivery of traffic in the wireless network according to the present invention. Those of skill in the art will understand that the present invention may be particularly beneficial with respect to data that is sensitive to latency such as, VoIP packets, emergency transmissions, etc. However, the present invention may also be implemented on an MU which requests a predefined priority as a function of its applications (e.g., voice, emergency calls, streaming video, push-to-talk, multicast, etc.) and/or user profile (e.g., foreman).

In step 205, the AP 20 receives traffic from the network 65. The method 200 will be described with reference to the AP 20 buffering the traffic, because the MUs, which it is bound for, are in the power-save mode. Those of skill in the art understand that incoming traffic bound for MUs which are in the wake mode is not typically buffered. A further scheduling mechanism may be applied to traffic for MUs in the wake mode, which will be described further below.

In step 210, the AP 20 determines a classification for packets included in the traffic utilizing, for example, a conventional packet classifier. When applied to the traffic, the packet classifier may determine a type of data included in each packet (e.g., voice, data, video, etc.). For example, a packet addressed to the MU 52 may include a VoIP call, while a packet addressed to the MU 54 may include an email or web page data. The packet classifier may return (e.g., flag) the packets which include data sensitive to latency, e.g., the VoIP call. The AP 20 may determine the recipient MU of each packet by analyzing address data therein (e.g., source address, destination address).

In step 215, the AP 20 generates a transmission schedule for the packet as a function of the classification. As described above, voice packets are sensitive to latency such that delay may induce jitter and/or packet loss degrading performance of the system 1. Thus, the AP 20 may schedule the voice and/or emergency packets for transmission prior to any non-critical packets (e.g., emails, web pages, etc.).

An exemplary embodiment of the transmission schedule may include an entry for each MU associated with a particular AP. For example, the AP 20 may include entries for the MUs 52-56. The AP 20 may have knowledge of a frame size buffered for each MU, and, as a result, may anticipate a number of slot times it would take for the MU to initiate a power-save poll and download its respective packets from the AP 20. In the above-described example, the entry for the MU 52 may be [52]=SlotTime_{—}1, whereas the entry for the MU 56 may be [56]=SlotTime_{—}10. Thus, the AP 20 may wait for 10 time slots (e.g., beacons) before it indicates that it has traffic buffered for the MU 56.

Optionally, when generating the transmission schedule, the AP 20 may take into account a priority request from one or more MUs that its traffic should receive priority over other packets. In one exemplary embodiment, an MU (e.g., the MU 54) may include a priority request in its communication with the AP 20. For example, the priority request may be included in an association request to the AP 20. The priority request may include data in a Capability Information Field in an Association Request frame indicating that the MU 54 intends to transmit and receive voice packets and/or that its traffic should be given a higher priority over non-critical packets (e.g., email, web page, etc.). The data may be a Diff Serv Code Point and/or a Device Type element including sub-elements such as, for example, a device identifier (e.g., a serial number), a voice capability element (e.g., VoIP capable using G.711 codec), a data rate element (e.g., a maximum data transfer speed of 50 kbps) and/or a protocol capability element (e.g., HTTP, TCP, IP, 802.1x, etc.).

In step 220, the AP 20 generates the TIM as a function of the transmission schedule. The AP 20 knows that the MUs 52-56 are in the power-save mode and must be notified that there is traffic buffered for them. As a result of the transmission schedule, the MUs which are to receive latency-sensitive packets may be notified about the traffic prior to the MUs receiving non-critical packets. In this manner, the AP 20 includes data in the TIM indicating that the MU 52 should switch to the wake mode upon receipt of the beacon. The data may further indicate that the MU(s) (e.g., the MU 54) which transmitted the priority requests should switch to the wake mode. That is, the traffic buffered for the MU 54 may be non-critical, but since the MU 54 requested priority for its traffic, the TIM may indicate that the MU 54 should switch to the wake mode.

In step 225, a beacon is transmitted by the AP 20 and includes the TIM indicating that the MUs 52 and 54 should switch to the wake mode. Upon receipt of the beacon, the MUs 52 and 54 switch to the wake mode and initiate a power-save poll, i.e., contend for access to the RF channel and download the respective packets from the AP 20. However, the packets for the MU 56 remain buffered by the AP 20, because the TIM did not indicate that the MU 56 should switch to the wake mode. The transmission schedule may indicate that the packets for the MU 56 should remain buffered for a predetermined number of beacons. For example, because the packets for the MU 56 contain non-critical data, they may be buffered for two more beacons. Thus, in a subsequent beacon, the AP 20 includes data in the TIM indicating that the MU 56 should switch to the wake mode. When the MU 56 hears the subsequent beacon, it may switch to the wake mode and initiate a power-save poll. In the power-save poll, the MU 56 contends for the RF channel and, when gaining access thereto, downloads the packets from the AP 20.

The method 200 has been described with reference to MUs which are in the power-save mode, and the AP 20 buffering the traffic bound therefor. However, the present invention may be utilized when the AP 20 receives, but does not buffer, traffic for MUs in the wake mode. In an exemplary embodiment, the AP 20 may take control of the RF channel using, for example, a SIFS interval. The AP 20 may then distribute the latency-sensitive packets and serve the priority requests for non-critical packets. Those of skill in the art will understand that this mechanism may be utilized with DCF and/or PCF compliant devices.

Several advantages are provided by the present invention in terms of power conservation and increased throughput. That is, because the AP staggers the indication that it is buffering data for the MUs, the MUs switch to the wake mode at different times and, as a result, a particular MU may contend with a smaller number of MUs for the RF channel. Thus, latency-sensitive data is more quickly delivered to the recipient MUs. Additionally, MUs which are not receiving latency-sensitive data or have not requested priority do not switch to and remain in the wake mode for a prolonged time thereby conserving battery power.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving packets addressed to a plurality of wireless computing units;
determining a classification of each packet;
generating a transmission schedule for the corresponding packet as a function of at least one of the classification and a priority request from at least one of the plurality of units;
generating an indication message as a function of the transmission schedule; and
wirelessly transmitting a signal including the indication message.

2. The method according to claim 1, wherein each of the plurality of units includes at least one of an image-based scanner, a laser-based scanner, an RFID reader, an RFID tag, a cell phone, a network interface card and a PDA.

3. The method according to claim 1, further comprising:
receiving an association request from the at least one of the plurality of units, the association request including the priority request.

4. The method according to claim 1, further comprising:
identifying selected ones of the units in a power save mode; and
buffering the packets addressed to the selected ones.

5. The method according to claim 1, wherein the classification includes at least one of voice, data, video and emergency.

6. The method according to claim 1, wherein the indication message is a traffic indication map (TIM).

7. The method according to claim 1, wherein the signal is a beacon.

8. An arrangement, comprising;
a communications arrangement receiving packets addressed to a plurality of wireless computing units; and
a processor determining a classification of each packet and generating a transmission schedule for the corresponding packet as a function of at least one of the classification and a priority request from at least one of the plurality of units, the processor generating an indication message as a function of the transmission schedule and transmitting a signal including the indication message.

9. The arrangement according to claim 8, wherein the arrangement is at least one of a switch, a router and an access point.

10. The arrangement according to claim 8, wherein the classification includes at least one of voice, data, video and emergency.

11. The arrangement according to claim 8, wherein the indication message is a traffic indication map (TIM).

12. The arrangement according to claim 8, wherein the signal is a beacon.

13. The arrangement according to claim 8, wherein the processor utilizes a packet classifier for determining the classification.

14. The arrangement according to claim 8, wherein the communications arrangement receives an association request from the at least one of the plurality of units, the association request including the priority request.

15. The arrangement according to claim 8, wherein the processor identifies selected ones of the units in a power save mode and buffers the packets addressed to the selected ones.

16. An arrangement, comprising:
a communications arrangement receiving a wireless signal from a network management arrangement (NMA), the signal including an indication message; and
a processor processing the indication message,
wherein, when the indication message includes first data indicating that the NMA is buffering a packet addressed to the arrangement, the processor switches from a first operating mode to a second operating mode, the communications arrangement only transmitting packets in the second operating mode.

17. The arrangement according to claim 16, wherein, when the indication message includes second data indicating that the NMA is not buffering the packet addressed to the arrangement, the processor remains in the first operating mode.

18. The arrangement according to claim 16, wherein the communications arrangement transmits a priority request to the NMA, the priority request instructing the NMA to transmit packets addressed to the arrangement within a predetermined time period.

19. The arrangement according to claim 16, wherein the arrangement includes at least one of an image-based scanner, a laser-based scanner, an RFID reader, an RFID tag, a cell phone, a network interface card and a PDA.

20. The arrangement according to claim 16, wherein the wireless signal is a beacon.

21. The arrangement according to claim 16, wherein the first operating mode is a power-save mode.

22. A system, comprising:
a network management arrangement (NMA); and
a plurality of wireless computing units wirelessly coupled to the NMA,
wherein the NMA receives packets addressed to the plurality of units, the NMA determines a classification of each packet and generates a transmission schedule for the corresponding packet as a function of at least one of the classification and a priority request from at least one of the plurality of units, and
wherein the NMA generates an indication message as a function of the transmission schedule and transmits a signal including the indication message.

23. The system according to claim 22, wherein the NMA includes at least one of a switch, a router, an access point and an access port.

24. The system according to claim 22, wherein each of the plurality of units includes at least one of an image-based scanner, a laser-based scanner, an RFID reader, an RFID tag, a cell phone, a network interface card and a PDA.

25. An arrangement, comprising:
a communication means for receiving a plurality of packets addressed to a plurality of wireless computing units;
a classifying means for determining a classification of each packet; and
a processing means for generating a transmission schedule for the corresponding packet as a function of at least one of the classification and a priority request from at least one of the plurality of units, the processing means generating an indication message as a function of the transmission schedule and transmitting a signal including the indication message.
